(19) United States
(12) Patent Application Publication
(10) Pub. No.: US 2003/0114994 A1
(43) Pub. Date: Jun. 19, 2003

(54) Air-conditioner monitor system

(76) Inventor: Kunihide Wada, Osaka (JP)

Correspondence Address: Nixon Peabody, Suite 800, 8180 Greensboro Drive, McLean, VA, 22102, US

(21) Appl. No.: 10/258,025

(22) PCT Filed: Apr. 20, 2001
(86) PCT No.: PCT/JP01/03427

(30) Foreign Application Priority Data
Apr. 20, 2000 (JP) 2000-118841

(51) Int. Cl. G06F 19/00

(52) U.S. Cl. 702/33

(57) ABSTRACT

Disclosed is an airconditioner monitoring system in which a monitoring unit (11) sends, upon receipt of a malfunction code from an airconditioner (12), the malfunction code to a database server (41) via a LAN (2) and via the Internet (3). The database server (41) checks the received malfunction code against a database (41a) and sends information about the malfunction to the monitoring unit (11). The monitoring unit (11) displays the received malfunction information.

### TECHNICAL FIELD

The present invention relates to an airconditioner monitoring system for monitoring the operational status of airconditioners.

### BACKGROUND ART

Airconditioner monitoring systems have been known in the prior art. Such a conventional airconditioner monitoring system is connected to a plurality of airconditioners and includes a monitoring unit having a display section on which performance data transmitted from each airconditioner are displayed, thereby making it possible to monitor the operational status of each airconditioner.

In the above-mentioned airconditioner monitoring system, it is constructed in such a way that any one of the airconditioners that has developed a malfunction will send a malfunction code to the monitoring unit. Upon receipt of the malfunction code, the monitoring unit displays only the malfunction code on the display section. Accordingly, in order to confirm concrete content of the malfunction that has occurred in the airconditioner and a troubleshooting procedure for the malfunction, the airconditioner administrative operator is required to refer to the operating manual describing both malfunction codes and information about possible malfunctions such as concrete content of a malfunction and a troubleshooting procedure for the malfunction. In other words, the airconditioner administrative operator has to confirm both concrete content of a malfunction and a troubleshooting procedure for the malfunction by checking a malfunction code displayed on the display section against its corresponding content described in the operating manual.

However, it is troublesome for the airconditioner administrative operator to have to confirm information about an occurring malfunction by referring to the operating manual. This causes inconvenience that dealing with a malfunction occurring in an airconditioner cannot be carried out with efficiency.

Further, it is always preferable to dealt, based on the latest information, with airconditioner malfunctions. However, in the above-mentioned way of confirming, based on a description given in the operating manual, malfunction information, there are cases in which the information requires updating, and there is the possibility that malfunctions cannot be dealt with in the most suitable way. On the other hand, it is possible to continuously update the descriptions of the operating manual with the latest information. However, such updating creates inconvenience, i.e., considerably increased costs.

Bearing in mind the above-described problems, the invention was made. Accordingly, an object of the invention is to make it possible to readily confirm, at an occurrence of a malfunction in an airconditioner, information about the malfunction such as information about a troubleshooting procedure for the malfunction. Further, another object of the invention is to provide a monitoring system which is constructed in such a way that the latest information as malfunction information can be obtained easily and inexpensively.

### DISCLOSURE OF THE INVENTION

In order to achieve the above-mentioned objects, the invention employs a monitoring unit capable of displaying information about a malfunction corresponding to a malfunction code.

More specifically, a first invention is intended for an airconditioner monitoring system for monitoring the operating status of an airconditioner (12) which is so constructed as to send, upon an occurrence of a malfunction, a malfunction code. And, the airconditioner monitoring system of the first invention comprises: a monitoring unit (11), connected to the airconditioner (12), for receiving a malfunction code sent by the airconditioner (12) upon an occurrence of a malfunction and for sending the malfunction code; and a data providing means (21, 41), connected to the monitoring unit (11), for receiving the malfunction code sent by the monitoring unit (11) and for sending, to the monitoring unit (11), information about a malfunction corresponding to the malfunction code, wherein the monitoring unit (11) is so constructed as to receive information about a malfunction from the data providing means (21, 41) and display the received malfunction information.

By virtue of the above-described construction, whenever a malfunction occurs in an airconditioner (12), the airconditioner (12) sends a malfunction code to the monitoring unit (11). Then the monitoring unit (11) sends the received malfunction code to the data providing means (21, 41). The data providing means (21, 41) sends, as a reply, information about a malfunction corresponding to the malfunction code (for example, concrete content of the malfunction and a troubleshooting procedure for the malfunction) to the monitoring unit (11). Upon receipt of the malfunction information, the monitoring unit (11) displays it. Based on the malfunction information displayed on the monitoring unit (11), the administrative operator of the airconditioner (12) is able to deal with the malfunction of the airconditioner (12).

In this way, the monitoring unit (11) displays information about a malfunction. In other words, there is no need for the administrative operator of the airconditioner (12) to confirm information about an occurring malfunction by making reference to the operating manual. This makes the operation more efficient.

Further, continuous updating of the data of the data providing means (21, 41) enables the airconditioner administrative operator to obtain the latest information whenever an airconditioner (12) falls into a state of malfunction. This makes it possible to quickly and properly deal with the malfunction of the airconditioner (12). Besides, the requirement is just to update the data of the data providing means (21, 41) to the latest information, thereby making it possible to reduce updating costs.

Preferably the monitoring unit (11) is so constructed as to display, when the airconditioner (12) is functioning properly, performance data of the airconditioner (12). In other words, preferably the airconditioner (12) sends performance data to the monitoring unit (11) when functioning properly.

Such arrangement enables the airconditioner administrative operator to supervise the airconditioner (12) by confirming performance data displayed on the monitoring unit (11) when the airconditioner (12) functions properly, i.e., when the airconditioner (12) develops no malfunctions (in other words, when no malfunction codes are sent from the airconditioner (12)). On the other hand, when the airconditioner (12) develops a malfunction, information about the malfunction is displayed on the monitoring unit (11), thereby enabling the airconditioner administrative operator to deal with the malfunction based on the malfunction information displayed.

Further, preferably the data providing means (21, 41) has a database (21a, 41a) which is so organized that a malfunction code is associated with information about a malfunction, and is so constructed as to check a received malfunction code against the database (21a, 41a) to determine information about a malfunction corresponding to the received malfunction code.

Such arrangement makes it possible to definitely and accurately determine information about a malfunction corresponding to a malfunction code, in the data providing means (21, 41). Therefore, it is possible for the airconditioner administrative operator to deal with the malfunction of the airconditioner (12) on the basis of exact information.

Further, continuous updating of the data of the database (21a, 41a) enables the airconditioner administrative operator to obtain the latest information. This makes it possible for the airconditioner administrative operator to quickly and properly deal with a malfunction of the airconditioner (12). Besides, the requirement is just to update the database (21a, 41a) to the latest information, thereby making it possible to reduce updating costs.

And, the airconditioner monitoring system may be constructed in such a way that a plurality of airconditioners (12) of the above-described type are provided and the monitoring unit (11) is connected, via a transmission means (14) capable of signal transmission, to each airconditioner (12) and is so constructed as to receive a malfunction code transmitted from each airconditioner (12) and display information about a malfunction corresponding to the received malfunction code.

As a result of such arrangement, it becomes possible to monitor the multiple airconditioners (12, 12, . . . ) with the single monitoring unit (11). And, for the case of an airconditioner monitoring system having a plurality of airconditioners, the monitoring unit (11) displays information about a malfunction. In other words, there is no need for the administrative operator of the airconditioner (12) to confirm information about an occurring malfunction by making reference to the operating manual. This makes the operation more efficient. Further, continuous updating of the data of the data providing means (21, 41) enables the airconditioner administrative operator to obtain the latest information whenever an airconditioner (12) develops a malfunction.

When monitoring the airconditioners (12) with the single monitoring unit (11) in such a way, it is advisable that the monitoring unit (11) is so constructed as to display malfunction information for each airconditioner (12).

Such arrangement makes it possible to identify an airconditioner (12) that has developed a malfunction from among the multiple airconditioners (12, 12, . . . ), thereby enabling the airconditioner administrative operator to deal promptly with the malfunction of the airconditioner (12).

And, the airconditioner (12) and the data providing means (21) may be connected together via a LAN (2).

An existing LAN (2) established in a building or the like in which the airconditioner (12) was installed may be used as the LAN (2). The use of the existing LAN (2) makes it possible to construct a data providing means (21) by making use of hardware provided on the LAN (2) and to facilitate for example the maintenance of the data providing means (21) thus constructed. Further, the use of the existing LAN (2) makes it possible to construct an airconditioner monitoring system at low cost.

Further, the airconditioner (12) and the data providing means (41) may be connected together via a WAN (3). The WAN (3) may be for example the Internet.

When connecting together the airconditioner (12) and the data providing means (41) via the WAN (3), it is advisable to install the data providing means (41) in a service center (4) which supervises the airconditioner (12), for maintaining the data providing means positioned at a distance from where the airconditioner (12) is installed.

Further, if a plurality of airconditioner monitoring systems installed at different facilities or buildings are each connected to the WAN (3), this makes it possible for the data providing means (41) to be shared between the multiple monitoring systems. Because of this, it becomes possible to provide the latest information to all the monitoring systems just by updating the data of the data providing means (41).

A second invention is also intended for an airconditioner monitoring system for monitoring the operating status of an airconditioner (12), and the airconditioner (12) is so constructed as to send, upon an occurrence of a malfunction, a malfunction code. And, the airconditioner monitoring system of the second invention comprises: a data providing means (21, 41), connected to the airconditioner (12), for receiving a malfunction code sent by the airconditioner (12) upon an occurrence of a malfunction and for responding to the received malfunction code by sending, to the airconditioner (12), information about a malfunction corresponding to the received malfunction code; and a monitoring unit (11), provided in the airconditioner (12), for displaying the malfunction information from the data providing means (21, 41) received by the airconditioner (12).

As a result of such arrangement, when an airconditioner (12) falls into a state of malfunction, the airconditioner (12) sends a malfunction code. The data providing means (21, 41) receives the malfunction code. The data providing means (21, 41) responds to the received malfunction code by sending information about a malfunction corresponding to the malfunction code to the airconditioner (12). The airconditioner (12) receives the malfunction information. And, the malfunction information is displayed on the monitoring unit (11) mounted on the airconditioner (12). The administrative operator of the airconditioner (12) deals, based on the malfunction information displayed on the monitoring unit (11), with the malfunction of the airconditioner (12).

In this way, the monitoring unit (11) displays information about a malfunction. Accordingly, like the first invention there is no need for the airconditioner administrative operator to confirm information about an occurring malfunction by making reference to the operating manual. This makes the operation more efficient. Further, continuous updating of the data of the data providing means (21, 41) enables the airconditioner administrative operator to obtain the latest information whenever an airconditioner (12) falls into a state of malfunction.

Preferably the monitoring unit (11) is so constructed as to display, when the airconditioner (12) is functioning properly, performance data of the airconditioner (12).

Further, preferably the data providing means (21, 41) has a database (21a, 41a) which is so organized that a malfunction code is associated with information about a malfunction, and is so constructed as to check a received malfunction code against the database (21a, 41a) to determine information about a malfunction corresponding to the received malfunction code.

Preferably, the airconditioner (12) and the data providing means (21) are connected together either via a LAN (2) or via a WAN (3).

A third invention is also intended for an airconditioner monitoring system for monitoring the operating status of an airconditioner (12), and the airconditioner (12) is so constructed as to send, upon an occurrence of a malfunction, a malfunction code. And, the airconditioner monitoring system of the third invention comprises a monitoring unit (11), connected to the airconditioner (12), for receiving a malfunction code sent by the airconditioner (12) upon an occurrence of a malfunction and for displaying information about a malfunction corresponding to the received malfunction code.

The monitoring unit (11) may be provided with a database so structured that malfunction codes are associated with information about malfunctions.

As a result of such arrangement, when an airconditioner (12) falls into a state of malfunction, the airconditioner (12) sends a malfunction code. The monitoring unit (11) receives the malfunction code. The monitoring unit (11) displays information about a malfunction corresponding to the malfunction code. The administrative operator of the airconditioner (12) deals, based on the malfunction information displayed on the monitoring unit (11), with the malfunction of the airconditioner (12).

In this way, the monitoring unit (11) displays information about a malfunction. Accordingly, like the first or second invention there is no need for the airconditioner administrative operator to confirm information about malfunctions by making reference to the operating manual. This makes the operation more efficient. Further, continuous updating of the data of the monitoring unit (11) enables the airconditioner administrative operator to obtain the latest information whenever an airconditioner (12) falls into a state of malfunction.

Preferably, the monitoring unit (11) is so constructed as to display, when the airconditioner (12) is functioning properly, performing data of the airconditioner (12).

And, preferably, a plurality of airconditioners (12) of the above-described type are provided and the monitoring unit (11) is connected, via transmission means (14) capable of signal transmission, to each airconditioner (12), and is so constructed as to receive a malfunction code transmitted from each airconditioner (12) and display information about a malfunction corresponding to the received malfunction code.

Further, preferably the monitoring unit (11) is so constructed as to display malfunction information for each airconditioner (12).

Preferably, the airconditioner (12) and the monitoring unit (11) are connected together either via a LAN (2) or via a WAN (3).

### BRIEF DESCRIPTION OF THE DRAWINGS

FIG. 1 is a schematic diagram showing an airconditioner monitoring system according to an embodiment of the invention;

FIG. 2 is an explanatory diagram showing an exemplary display of a monitoring unit when an airconditioner is functioning properly; and

FIG. 3 is an explanatory diagram showing an exemplary display of the monitoring unit when an airconditioner is malfunctioning.

### BEST MODE FOR CARRYING OUT THE INVENTION

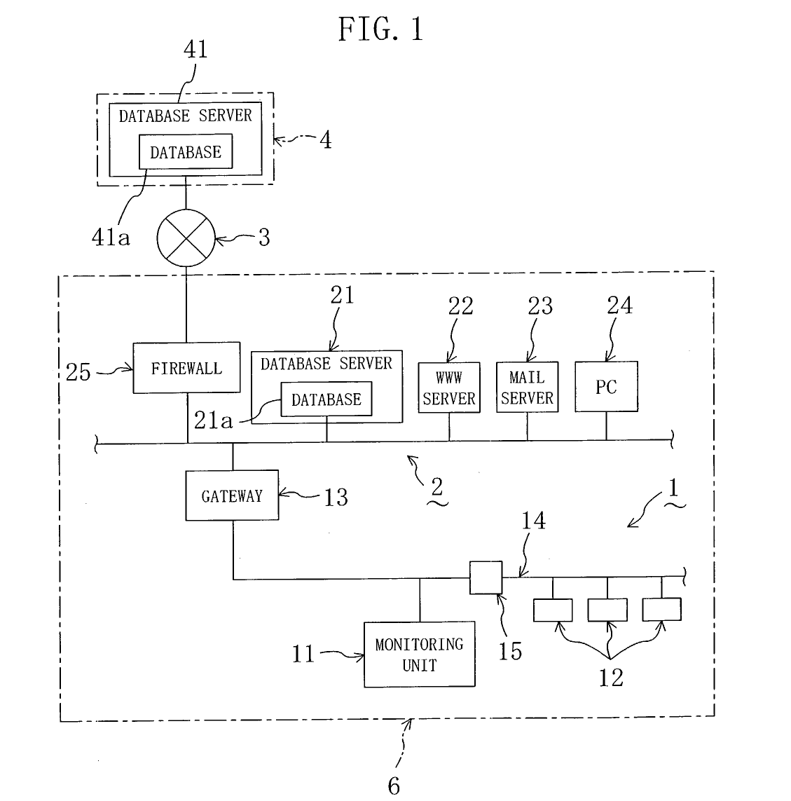

Referring to FIG. 1, there is shown an airconditioner monitoring system according to an embodiment of the invention. The reference numeral 1 denotes an airconditioner transmission control system including a plurality of airconditioners (12, 12, . . . ). The reference numeral 2 denotes a LAN constructed in a building (6) in which the transmission control system (1) has been installed. The reference numeral 3 denotes the Internet as a WAN (Wide Area Network).

The airconditioner transmission control system (1) is constructed by connection of each of the airconditioners (12, 12, . . . ) to a transmission line (14) as a transmission means capable of signal transmission. Each airconditioner (12) is constructed in such a way that it sends, during normal operation (when no malfunctions occur), various performance data to a monitoring unit (11) which will be described later via the transmission line (14). On the other hand, each airconditioner (12) sends, when it malfunctions, a malfunction code corresponding to the malfunction to the monitoring unit (11).

The monitoring unit (11) for displaying performance data of each airconditioner (12) is connected to the transmission line (14). Connected between the monitoring unit (11) and the airconditioners (12, 12, . . . ) is an adapter (15) for controlling the transmission of signals.

The monitoring unit (11) is fed performance data of each airconditioner (12) and outputs an instruction signal about the operation of each airconditioner (12). The monitoring unit (11) is a human interface for displaying performance data of each airconditioner (12), for setting the operation of each airconditioner (12), and for changing the operational setting of each airconditioner (12).

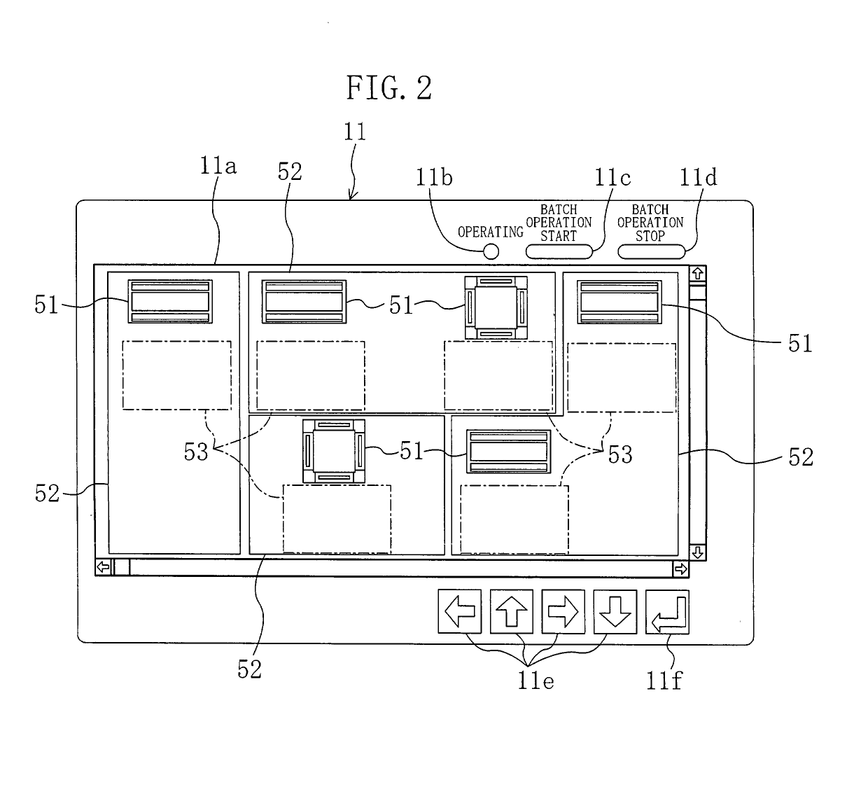

In other words, the monitoring unit (11) has, as shown in FIG. 2, a display section (11a) which is for example a liquid crystal display of the matrix type. The display section (11a) displays performance data of each airconditioner (12). Further, the monitoring unit (11) is provided, at its upper area, with a lamp (11b) which turns on when each airconditioner (12) is in operation, a batch operation start button (11c) by which all the airconditioners (12, 12, . . . ) are activated, and a batch operation stop button (11d) by which all the airconditioners (12, 12, . . . ) are stopped. Additionally, the monitoring unit (11) is provided, at its lower area, with cursor moving keys (11e) for moving for example a cursor vertically and laterally in a display screen displayed on the display section (11a), and an enter key (11f) for executing for example a menu displayed on the screen.

Here, a screen display manner in the display section (11a) will be described. The airconditioners (12, 12, . . . ) of the airconditioner monitoring unit (11) are assigned different numbers. The display section (11a) displays, for each airconditioner (12), an image representation (51) of each airconditioner (12) and corresponding information (53) such as the number, model name, current mode of operation, temperature control, set temperature of each airconditioner (12). Further, the image representation (51) of each airconditioner (12) and the information (53) of each airconditioner (12) are arranged in groups (52, 52, . . . ) for each block of a floor in which the airconditioners (12, 12, . . . ) were installed (for example, “3F West Block”, “3F Central block”, and so on). Further, a scroll function is added to the display screen, because of which the display screen can be moved vertically and horizontally.

The monitoring unit (11) is constructed in such a way that it receives, when an airconditioner (12) falls into a state of malfunction, a malfunction code transmitted from the airconditioner (12). Upon receipt of the malfunction code, the monitoring unit (11) displays, on the display section (11a), the malfunction code and information about a malfunction corresponding to the malfunction code, as will be described later.

As can be seen from FIG. 1, connected to the LAN (2) are a personal computer (PC) (24) which is a client, a database server (21) which provides data to the PC (24), a WWW (World Wide Web) server (22) which provides an HTML (Hyper Text Markup Language) document to the PC (24), and a mail server (23) which relays an e-mail communicated between the PCs (24). The LAN (2) is constructed as an intranet making utilization of internet technologies.

Since the LAN (2) and the airconditioner transmission control system (1) differ from each other in signal transmission method, the LAN (2) and the airconditioner transmission control system (1) are connected together via a gateway (13) capable of conversion of the signal transmission method of the LAN (2) into the signal transmission method of the airconditioner transmission control system (1).

Further, the LAN (2) is connected to the Internet (3) via a firewall (25) for preventing unauthorized access to the LAN (2) from the Internet (3).

The Internet (3) is connected to a database server (41) serving as a data providing means installed at a service center (4). The database server (41) has a database (41a) so organized that malfunction codes are associated with information about malfunctions such as concrete content of a malfunction and a troubleshooting procedure for the malfunction. The database server (41) is constructed in such a way that it receives, via the LAN (2) and via the Internet (3), a malfunction code transmitted from the monitoring unit (11). Upon receipt of the malfunction code, the database server (41) checks the malfunction code against the database (41a) to determine concrete content of a malfunction corresponding to the malfunction code and a troubleshooting procedure for the malfunction. Thereafter, the database server (41) responds to the malfunction code by sending the malfunction content and the troubleshooting procedure to the monitoring unit (11).

Next, the operation of monitoring the airconditioners in the airconditioner monitoring system will be described.

Each airconditioner (12, 12, . . . ) transmits, during normal operation, data such as performance data to the monitoring unit (11) via the transmission line (14). Because of this, an operating status of each airconditioner (12) is displayed on the display section (11a) of the monitoring unit (11) (see FIG. 2), whereby the airconditioners (12, 12, . . . ) can be monitored.

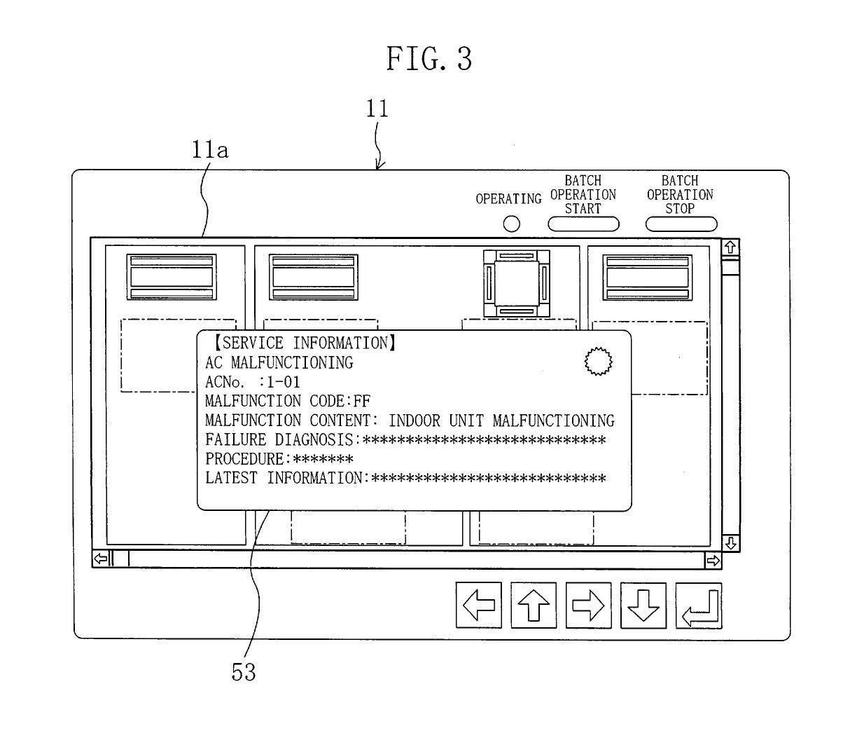

On the other hand, when any one of the airconditioners (12, 12, . . . ) falls into a state of malfunction, the malfunctioning airconditioner (12) sends a malfunction code to the monitoring unit (11). Upon receipt of the malfunction code, the monitoring unit (11) sends it to the database server (41) of the service center (4) via the LAN (2) and via the Internet (3). The database server (41) checks the malfunction code against the database (41a) to determine concrete content of a malfunction corresponding to the malfunction code and a troubleshooting procedure for the malfunction. Thereafter, the database sever (41) responds to the malfunction code by sending the malfunction content and the troubleshooting procedure to the monitoring unit (11). And, upon receipt of the malfunction content and the troubleshooting procedure, the monitoring unit (11) displays them on the display section (11a). As a result, a new window (53) is displayed on the screen at the aforesaid normal operation time (see FIG. 2), for example as shown in FIG. 3. The number (AC number) of an airconditioner (12) which has fallen into a state of malfunction, malfunction code, concrete content of the malfunction, failure diagnosis, and troubleshooting procedure are displayed within the new window (53). Further, if there is the latest information relating to the troubleshooting procedure, such information is also displayed.

Thus, the administrative operator of the airconditioners (12, 12, . . . ) is able to deal, based on information displayed on the monitoring unit (11), with a malfunction occurring in an airconditioner (12).

In the way as described above, in accordance with the present airconditioner monitoring system, a malfunction code and various information about a malfunction corresponding to the malfunction code such as concrete content of the malfunction and a troubleshooting procedure for the malfunction is displayed on the monitoring unit (11), together with the identification number of a malfunctioning airconditioner (12). This enables the airconditioner administrative operator to deal efficiently with a malfunction occurring in an airconditioner (12).

In addition to the above, continuous updating of the database (41a) of the service center (4) located at a distance from the airconditioners (12, 12, . . . ) makes it possible for the airconditioner administrative operator to obtain the latest information whenever an airconditioner (12) malfunctions. Thus, the airconditioner administrative operator is able to deal quickly and properly with a malfunction occurring in an airconditioner (12). Further, it is possible to provide the latest information to the airconditioner administrative operator at low cost just by updating the database (41a).

Besides, since the present airconditioner monitoring system can be constructed by making utilization of the LAN (2) previously established in the building (6) and the Internet (3), this makes it possible to maintain the database (41a) with ease and, in addition, it is possible to inexpensively construct the system itself

Further, if an airconditioner monitoring system installed at another establishment or building which is under control of the service center (4) is connected to the Internet (3) (not shown), this makes it possible to share the database (41a) of the service center (4) between a plurality of monitoring systems. In this case, it is possible to provide the latest information to all the airconditioner monitoring systems just by updating the database (41a).

In the above-mentioned embodiment, the database (41a) in which malfunction codes are associated with information about malfunctions is provided in the database server (41) of the service center (4) connected to the Internet (3). However, it may be arranged such that the database server (21) provided in the LAN (2) is equipped with a database (21a) in which malfunction codes are associated with information about malfunctions. Also in this case, by making utilization of an existing LAN (2), it becomes possible to inexpensively construct an airconditioner monitoring system, and it also becomes possible to construct and maintain the database (21a) with ease.

Further, in the above-mentioned embodiment, the database server (41) having the database (41a) is provided in addition to the monitoring unit (11). However, it may be arranged in such a way that the monitoring unit (11) has a database. In such a case, the provision of the database server (41) is omitted accordingly. Even in such an arrangement, information about a malfunction is displayed on the monitoring unit (11), so that the airconditioner administrative operator is still able to confirm concrete content of a malfunction and a troubleshooting procedure for the malfunction with ease. Besides, the latest information can be obtained just by updating the database of the monitoring unit (11).

In such a way as describe above, the monitoring unit (11) provided with a database may be provided on the transmission line (14). Alternatively, the monitoring unit (11) may be provided on the LAN (2), in which case the monitoring unit (11) is connected, via the LAN (2), to each airconditioner (12). Further, it may be arranged in such a way that the monitoring unit (11) provided with such a database is installed for example in the service center (4). In such an arrangement, the monitoring unit (11) and each airconditioner (12) are connected together via the Internet (3).

Further, in the above-described embodiment, the plural airconditioners (12, 12, . . . ) are connected to the transmission line (14) and the monitoring unit (11) is connected to the transmission line (14). Alternatively, the monitoring unit (11) may be provided in each airconditioner (12). In this case, when there occurs a malfunction in an airconditioner (12), the airconditioner (12) directly sends a malfunction code to the database server (21, 41) via the LAN (2) or via the Internet (3), and the airconditioner (12) receives information about the malfunction from the database server (21, 41). And, the monitoring unit (11) provided in the airconditioner (12) displays the malfunction information.

Furthermore, the airconditioner monitoring system according to the invention is applicable not only to a case in which a plurality of airconditioners (12) are provided, but also to a case in which only a single airconditioner (12) is provided.

### INDUSTRIAL APPLICABILITY

As has been described, the invention is useful for airconditioner monitoring systems for monitoring the operating status of airconditioners. Particularly, the invention provides high industrial applicability because information about an occurring malfunction is displayed on the airconditioner monitoring system. This enables an airconditioner administrative operator to deal properly with a malfunction occurring in an airconditioner.

What is claimed is:

1. An airconditioner monitoring system for monitoring the operating status of an airconditioner (12),
said airconditioner (12) being so constructed as to send, upon an occurrence of a malfunction, a malfunction code,
said airconditioner monitoring system comprising:
a monitoring unit (11), connected to said airconditioner (12), for receiving a malfunction code sent by said airconditioner (12) upon an occurrence of a malfunction and for sending said malfunction code, and
data providing means (21, 41), connected to said monitoring unit (11), for receiving said malfunction code sent by said monitoring unit (11) and for sending, to said monitoring unit (11), information about a malfunction corresponding to said malfunction code,
wherein said monitoring unit (11) is so constructed as to receive information about a malfunction from said data providing means (21, 41) and display said received malfunction information.

2. The airconditioner monitoring system of claim 1, wherein said monitoring unit (11) is so constructed as to display, when said airconditioner (12) is functioning properly, performance data of said airconditioner (12).

3. The airconditioner monitoring system of claim 1, wherein said data providing means (21, 41) has a database (21a, 41a) which is so organized that a malfunction code is associated with information about a malfunction and wherein said data providing means (21, 41) is so constructed as to check a received malfunction code against said database (21a, 41a) to determine information about a malfunction corresponding to said received malfunction code.

4. The airconditioner monitoring system of claim 1,
wherein:
a plurality of said airconditioners (12) are provided, and said monitoring unit (11) is connected, via transmission means (14) capable of signal transmission, to each said airconditioner (12) and is so constructed as to receive a malfunction code transmitted from each said airconditioner (12) and display information about a malfunction corresponding to said received malfunction code.

5. The airconditioner monitoring system of claim 4, wherein said monitoring unit (11) is so constructed as to display malfunction information for each said airconditioner (12).

6. The airconditioner monitoring system of claim 1, wherein said airconditioner (12) and said data providing means (21) are connected together via a LAN (2).

7. The airconditioner monitoring system of claim 1, wherein said airconditioner (12) and said data providing means (41) are connected together via a WAN (3).

8. An airconditioner monitoring system for monitoring the operating status of an airconditioner (12),
said airconditioner (12) being so constructed as to send, upon an occurrence of a malfunction, a malfunction code,
said airconditioner monitoring system comprising:
data providing means (21, 41), connected to said airconditioner (12), for receiving a malfunction code sent by said airconditioner (12) upon an occurrence of a malfunction and for responding to said received malfunction code by sending, to said airconditioner (12), information about a malfunction corresponding to said received malfunction code, and
a monitoring unit (11), provided in said airconditioner (12), for displaying said malfunction information from said data providing means (21, 41) received by said airconditioner (12).

9. The airconditioner monitoring system of claim 8, wherein said monitoring unit (11) is so constructed as to display, when said airconditioner (12) is functioning properly, performance data of said airconditioner (12).

10. The airconditioner monitoring system of claim 8, wherein said data providing means (21, 41) has a database (21a, 41a) which is so organized that a malfunction code is associated with information about a malfunction and wherein said data providing means (21, 41) is so constructed as to check a received malfunction code against said database (21a, 41a) to determine information about a malfunction corresponding to said received malfunction code.

11. The airconditioner monitoring system of claim 8, wherein said airconditioner (12) and said data providing means (21) are connected together via a LAN (2).

12. The airconditioner monitoring system of claim 8, wherein said airconditioner (12) and said data providing means (41) are connected together via a WAN (3).

13. An airconditioner monitoring system for monitoring the operating status of an airconditioner (12),
said airconditioner (12) being so constructed as to send, upon an occurrence of a malfunction, a malfunction code,
said airconditioner monitoring system comprising:
a monitoring unit (11), connected to said airconditioner (12), for receiving a malfunction code sent by said airconditioner (12) upon an occurrence of a malfunction and for displaying information about a malfunction corresponding to said received malfunction code.

14. The airconditioner monitoring system of claim 13, wherein said monitoring unit (11) is so constructed as to display, when the airconditioner (12) is functioning properly, performing data of said airconditioner (12).

15. The airconditioner monitoring system of claim 13,
wherein:
a plurality of said airconditioners (12) are provided, and
said monitoring unit (11) is connected, via transmission means (14) capable of signal transmission, to each said airconditioner (12) and is so constructed as to receive a malfunction code transmitted from each said airconditioner (12) and display information about a malfunction corresponding to said received malfunction code.

16. The airconditioner monitoring system of claim 15, wherein said monitoring unit (11) is so constructed as to display malfunction information for each said airconditioner (12).

17. The airconditioner monitoring system of claim 13, wherein said airconditioner (12) and said monitoring unit (11) are connected together via a LAN (2).

18. The airconditioner monitoring system of claim 13, wherein said airconditioner (12) and said monitoring unit (11) are connected together via a WAN (3).
